(19) United States
(12) Patent Application Publication
(10) Pub. No.: US 2026/0259326 A1
(43) Pub. Date: Sep. 3, 2026

(54) LIGHT DETECTION DEVICE AND RANGING SYSTEM

(71) Applicant: SONY SEMICONDUCTOR SOLUTIONS CORPORATION, KANAGAWA (JP)

(72) Inventor: TAKUYA YOKOYAMA, KANAGAWA (JP)

(21) Appl. No.: 19/159,618

(22) PCT Filed: Mar. 6, 2024
(86) PCT No.: PCT/JP2024/008430

§ 371 Date: Aug. 26, 2025

(30) Foreign Application Priority Data
Mar. 23, 2023 (JP) 2023-047100

(51) Int. Cl. G01S 17/894; G01S 7/481; G01S 7/4865; G01S 17/931

(52) U.S. Cl. CPC G01S 17/894; G01S 7/4816; G01S 7/4865; G01S 17/931

(57) ABSTRACT

The disclosure provides a light detection device and a ranging system capable of suppressing a deterioration in ranging accuracy. The present disclosure provides a light detection device including a laser light source that irradiates a target with laser light on the basis of a light emission timing, a pixel array section including a plurality of pixels each of which is capable of generating a detection signal corresponding to an amount of received light of reflected light from the target, a signal processing section that generates a distance value to the target on the basis of information regarding a difference between the light emission timing and a generation timing of the detection signal, and a control section capable of executing at least one of detection processing of a deviation time between the light emission timing and the generation timing of the detection signal, coordinate deviation detection processing of the plurality of pixels, and setting processing of the light emission timing.

### TECHNICAL FIELD

The present disclosure relates to a light detection device and a ranging system.

### BACKGROUND ART

A ranging system that measures a distance to an object (target) on the basis of time of flight (ToF) is generally known. TOF includes direct TOF (dTOF) and indirect ToF (iTOF) in general. In the direct ToF, laser light from a laser light source is emitted as pulsed light via a lens, and a photon is detected by a light receiving element referred to as a single photon avalanche diode (SPAD) from reflected light from the object irradiated with each pulsed light.

This is a technique of converting a carrier generated by this into an electric signal pulse using avalanche multiplication and inputting the same to a time to digital converter (TDC) to measure arrival time of the reflected light and calculate the distance to the object.

Furthermore, in order to expand a monitoring range, monitoring is performed using a plurality of light detection devices in some cases. In such a case, a blind spot of the monitoring range can be eliminated by partially overlapping monitoring areas.

### CITATION LIST

### Patent Document

Patent Document 1: Japanese Patent Application Laid-Open No. 2022-21826

### SUMMARY OF THE INVENTION

### Problems to be Solved by the Invention

However, there is a possibility that a timing deviation or a positional displacement occurs between a plurality of light detection devices.

Therefore, the present disclosure provides a light detection device and a ranging system capable of suppressing a deterioration in ranging accuracy.

### Solutions to Problems

In order to solve the above-described problem, according to the present disclosure,
provided is a light detection device including
a laser light source that irradiates a target with laser light on the basis of a light emission timing;
a pixel array section including a plurality of pixels each of which is capable of generating a detection signal corresponding to an amount of received light of reflected light from the target;
a signal processing section that generates a distance value to the target on the basis of information regarding a difference between the light emission timing and a generation timing of the detection signal; and
a control section capable of executing at least one of detection processing of a deviation time between the light emission timing and the generation timing of the detection signal, coordinate deviation detection processing of the plurality of pixels, and setting processing of the light emission timing.

The control section may detect a deviation between the light emission timing and the generation timing of the detection signal on the basis of a measured time difference between the generation timing of the detection signal generated for reflected light of the target arranged in a predetermined position from the laser light source and the light emission timing in a case of executing the detection processing of the deviation time.

The control section may detect a difference between a time obtained by dividing an added distance of a first distance from the laser light source to the position and a second distance from the position to the pixel array section by a light speed and the measured time difference as the deviation time.

The control section may calibrate the light emission timing or the generation timing of the detection signal on the basis of the deviation time.

The signal processing section may correct the distance value on the basis of the deviation time.

A mirror that changes an irradiation direction of the laser light is further included, in which
the target may be the mirror, and
the control section may control an orientation of the mirror to an orientation in which the laser light is incident on the pixel array section in a case of executing the detection processing of the deviation time.

The plurality of pixels is arranged in a matrix, and
in a case of executing the coordinate deviation detection processing,
the control section may cause a second laser light source different from the laser light source to irradiate the target with laser light in a predetermined shape, and detect coordinate deviation on the basis of a first position with respect to the plurality of pixels of reflected light of the laser light in a predetermined shape.

The control section may cause a second pixel array section different from the pixel array section to receive the reflected light of the laser light in a predetermined shape, and detect the coordinate deviation on the basis of a difference between a second position of the reflected light of the laser light in a predetermined shape with respect to a plurality of pixels of the second pixel array section and the first position.

The signal processing section is capable of generating a two-dimensional distance image based on detection signals of the plurality of pixels, and
the control section may change coordinates of the two-dimensional distance image on the basis of the coordinate deviation.

The laser light in a predetermined shape may be reflected as a square light pattern in a row direction of the pixel array section,
the pixel array section is capable of partially driving for each of a plurality of rectangular areas including a first side in the row direction and a second side in a column direction orthogonal to the row direction,
the control section may cause the pixel array section to partially drive for each rectangular area in a case of detecting the reflected light,
select an area in which a light receiving amount is highest among the plurality of areas and detect the first position on the basis of the area in which the light receiving amount is highest.

The control section may select the area in which the light receiving amount is highest from the plurality of areas on the basis of the detection signal, then cause the pixel array section to partially drive for each of a plurality of rectangular second areas in which the second side is made shorter, select a second area in which the light receiving amount is highest from the plurality of second areas, and detect the first position on the basis of the second area in which the received light amount is highest.

The control section
may cause the pixel array section to partially drive for each of a plurality of rectangular third areas in which the second side is made shorter in a range of the pixel array section limited on the basis of the second area in which the light receiving amount is highest, select a third area in which the light receiving amount is highest from the plurality of third areas, and detect the first position on the basis of the third area in which the received light amount is highest.

In a case where pixels that generate the detection signal of a predetermined value or more in the area are discontinuous in the row direction, the control section
may detect that a rotational deviation occurs between an irradiation optical system of the second laser light source and a light receiving optical system of the pixel array section.

In a case of executing the setting processing of the light emission timing, the control section
may cause a second laser light source different from the laser light source to irradiate the target with laser light at predetermined intervals, and
set the light emission timing of the laser light source on the basis of the generation timing of the detection signal.

The control section may set the light emission timing of the laser light source on the basis of an intermediate point of time of generation timings of the detection signals continuous in time series.

In order to solve the above-described problem, according to the present disclosure,
provided is a ranging system including: a plurality of light detection devices, irradiation ranges of laser light of which overlap with each other, in which
each of the plurality of light detection devices includes:
a laser light source that irradiates a target with laser light on the basis of a light emission timing;
a pixel array section including a plurality of pixels each of which is capable of generating a detection signal corresponding to an amount of received light of reflected light from the target; and
a signal processing section that generates a distance value to the target on the basis of information regarding a difference between the light emission timing and a generation timing of the detection signal,
and at least one light detection device of the plurality of light detection devices further includes a control section capable of executing at least one of detection processing of a deviation time between the light emission timing and the generation timing of the detection signal, coordinate deviation detection processing of the plurality of pixels, and setting processing of the light emission timing.

In order to solve the above-described problem, according to the present disclosure,
provided is a ranging system including: a plurality of light detection devices, irradiation ranges of laser light of which overlap with each other; and
an overall control section capable of controlling each of the plurality of light detection devices, in which
each of the plurality of light detection devices includes:
a laser light source that irradiates a target with laser light on the basis of a light emission timing;
a pixel array section including a plurality of pixels each of which is capable of generating a detection signal corresponding to an amount of received light of reflected light from the target; and
a signal processing section that generates a distance value to the target on the basis of information regarding a difference between the light emission timing and a generation timing of the detection signal,
and the overall control section is capable of executing at least one of detection processing of a deviation time between the light emission timing and the generation timing of the detection signal, coordinate deviation detection processing of the plurality of pixels, and setting processing of the light emission timing.

### BRIEF DESCRIPTION OF DRAWINGS

FIG. 1 is a block diagram illustrating an example of a schematic configuration of a ranging system according to a disclosed embodiment.

FIG. 2 is a diagram illustrating an example in which the ranging system is mounted on a vehicle.

FIG. 3 is a block diagram illustrating a detailed configuration example of a ranging device.

FIG. 4 is a diagram illustrating a configuration example of a light emitting device.

FIG. 5 is a diagram illustrating an example of a flash-type optical system.

FIG. 6 is a diagram illustrating a schematic configuration of an optical system of the ranging system according to the present embodiment.

FIG. 7 is a diagram illustrating an example of a schematic configuration of a pixel array illustrated in FIG. 3.

FIG. 8 is a block diagram illustrating a configuration regarding calibration processing of an overall control section.

FIG. 9 is a diagram schematically illustrating a normal operation of a scan-type optical system.

FIG. 10 is a diagram illustrating a histogram example at the time of normal operation of FIG. 9.

FIG. 11 is a diagram schematically illustrating a ranging distance of a target.

FIG. 12 is a diagram schematically illustrating an example of detecting a deviation between a light emission timing and a measurement start timing.

FIG. 13 is a diagram illustrating a histogram example in a first mode.

FIG. 14 is a diagram schematically illustrating a case where a deviation occurs in an optical axis of the light emitting device.

FIG. 15 is a diagram illustrating an example of detection processing in a second mode by a second detecting section.

FIG. 16 is a diagram schematically illustrating coordinate correction data.

FIG. 17 is a diagram illustrating an example in which a rotational deviation occurs in an optical axis of an optical system between ranging devices.

FIG. 18 is a diagram schematically illustrating a detection example in a third mode.

FIG. 19 is a flowchart illustrating a detection processing example according to the present embodiment.

FIG. 20 is a block diagram illustrating an example of a schematic configuration of a vehicle control system.

FIG. 21 is an explanatory diagram illustrating an example of installation positions of an outside-vehicle information detecting section and an imaging section.

### MODE FOR CARRYING OUT THE INVENTION

Hereinafter, an embodiment of a light detection device and a ranging system will be described with reference to the drawings. Hereinafter, main component parts of the light detection device and the ranging system will be mainly described, but the light emitting device and the ranging system may have component parts and functions that are not illustrated or described. The following description is not intended to exclude component parts and functions that are not illustrated or described.

### One Embodiment

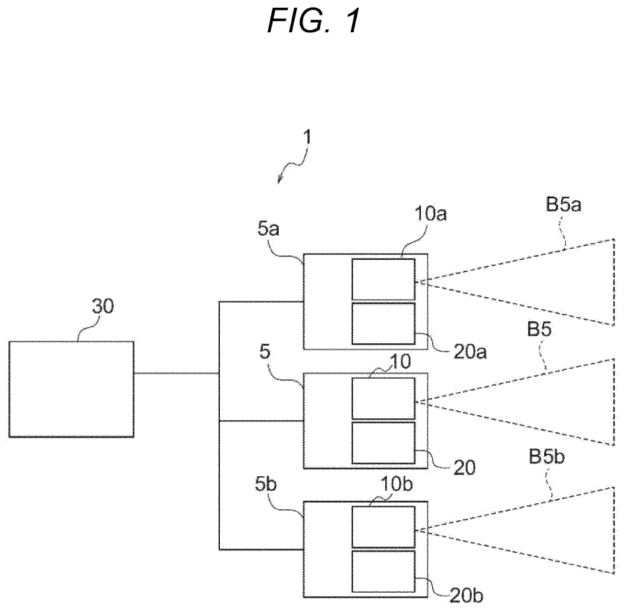

FIG. 1 is a block diagram illustrating an example of a schematic configuration of a ranging system 1 according to an embodiment of the present disclosure. As illustrated in FIG. 1, the ranging system 1 is a system capable of monitoring a plurality of monitoring areas B5a, B5, and B5b, and includes a plurality of light detection devices 5a, 5, and 5b and an overall control section 30. Furthermore, the light detection devices 5a, 5, and 5b include light emitting devices 10a, 10, and 10b and ranging devices 20a, 20, and 20b, respectively. That is, the ranging system 1 is a sensor system including a light source and a ToF sensor, and each of the light detection devices 5a, 5, and 5b is configured to emit laser light to ranges of the monitoring areas B5a, B5, and B5b and detect reflected light reflected by a target.

Here, the target may be one or more objects present within an angle of view of the ranging system 1. Note that, the light emitting devices 10a, 10, and 10b and ranging devices 20a, 20, and 20b will be described later in detail. Furthermore, in the present embodiment, an example of direct TOF (dTOF) will be described, but the present invention is not limited thereto. For example, indirect TOF (iTOF) may be used. Furthermore, in the present embodiment, an example in which the plurality of light detection devices 5a, 5, and 5b includes three devices will be described, but the present invention is not limited thereto. For example, the plurality of light detection devices 5a, 5, and 5b may include two or more devices, and for example, the ranging system 1 may include five, eight, twelve light detection devices.

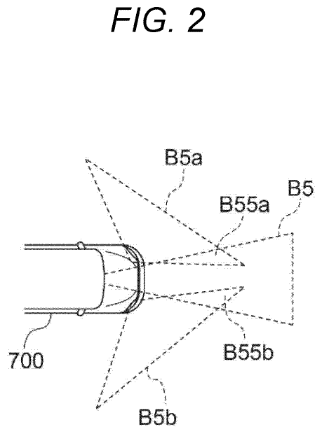

FIG. 2 is a diagram illustrating an example in which the ranging system 1 is mounted on a vehicle 700. As illustrated in FIG. 2, overlapping areas B55a, B55b and the like of the monitoring areas are provided in the plurality of monitoring areas B5a, B5, and B5b (refer to FIG. 1). As a result, the plurality of monitoring areas B5a, B5, and B5b (refer to FIG. 1) is formed without blind spots. In other words, two-dimensional distance images generated by the plurality of light detection devices 5a, 5, and 5b can be continuously formed.

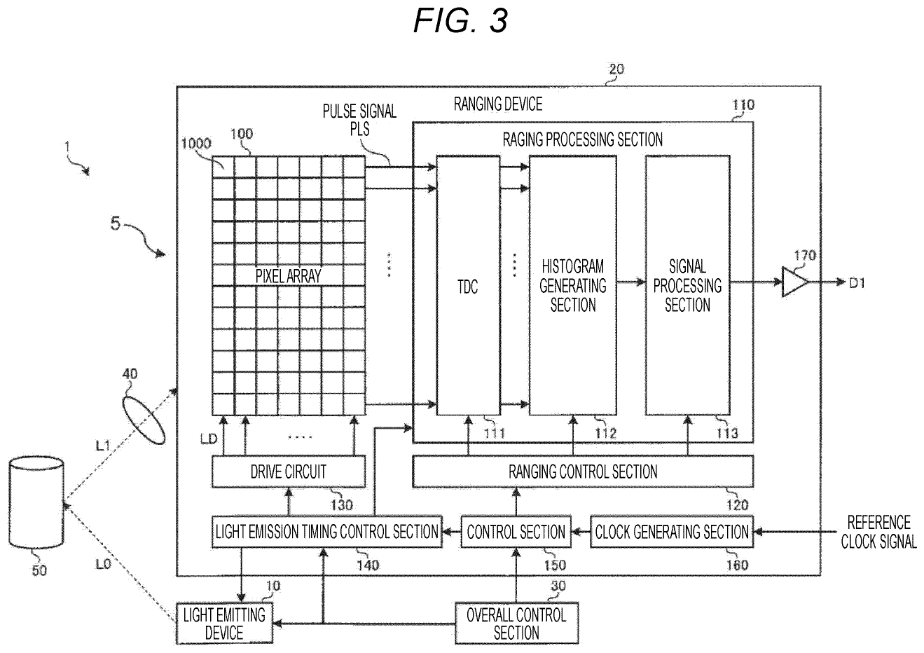

FIG. 3 is a block diagram illustrating a detailed configuration example of the ranging device 20. Note that, the light emitting devices 10a and 10b have the configuration equivalent to that of the light emitting device 10, and the ranging devices 20a and 20b have the configuration equivalent to that of the ranging device 20. Therefore, descriptions of the light emitting devices 10a and 10b and the ranging devices 20a and 20b may be omitted in some cases by describing the light emitting device 10 and the ranging device 20.

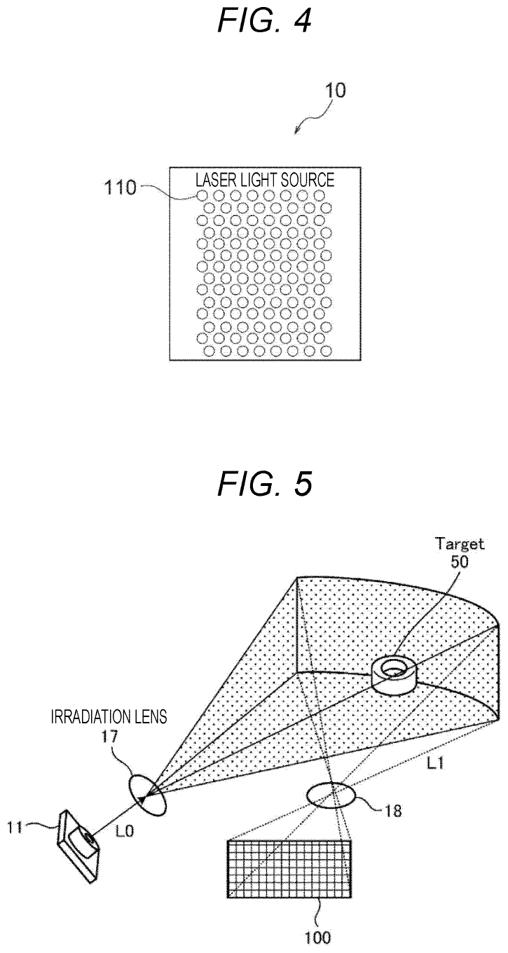

FIG. 4 is a diagram illustrating a configuration example of the light emitting device 10. The light emitting device 10 is configured to emit laser light (irradiation light) L0 toward a target 50 under the control of the overall control section 30. The light emitting device 10 emits the laser light L0 at a predetermined light emission cycle by performing a light emitting operation of alternately repeating light emission and non-light emission according to an instruction from the overall control section 30.

As illustrated in FIG. 4, the light emitting device 10 is, for example, a laser array section, and includes a plurality of light emitting elements 101 arranged two-dimensionally along a light emitting surface. The light emitting device 10 can irradiate the target 50 with laser light as irradiation light. The irradiation light is generated by light emission of the plurality of light emitting elements 101, and is applied in a predetermined direction. For each light emitting element 101, for example, a vertical cavity surface emitting laser (VCSEL) can be used. Note that, the present invention is not limited thereto, and various light sources capable of emitting light having a predetermined wavelength can be used. Note that, the light emitting device 10 according to the present embodiment corresponds to a laser light source.

As illustrated in FIG. 3 again, a light receiving section optical system 40 includes a lens that forms an image on a light receiving surface of the ranging device 20. A photon emitted from the light emitting device 10 and reflected by the target 50 is incident on the light receiving section optical system 40 as a reflected light pulse L1. Note that, the reflected light pulse L1 is referred to as reflected light in some cases.

As illustrated in FIG. 3, the ranging device 20 includes a pixel array 100, a ranging processing section 110, a ranging control section 120, a drive circuit 130, a light emission timing control section 140, a control section 150, a clock generating section 160, and an output section 170. The ranging device 20 is configured to detect the reflected light pulse L1 on the basis of an instruction from the overall control section 30. Then, the ranging device 20 generates a distance image on the basis of a detection result, and outputs image data of the generated distance image as distance information D1 from the output section 170.

The pixel array 100, the ranging processing section 110, the ranging control section 120, the drive circuit 130, the light emission timing control section 140, the control section 150, the clock generating section 160, and the output section 170 can be arranged on one semiconductor chip. In contrast, the ranging device 20 may have a configuration in which a first semiconductor chip and a second semiconductor chip are stacked. In this case, for example, a configuration is conceivable to arrange a part (photoelectric conversion section 1001) of the pixel array 100 on the first semiconductor chip and arrange the other part included in the ranging device on the second semiconductor chip.

In FIG. 3, the overall control section 30 controls an operation of an entire ranging system 1 according to, for example, a program incorporated in advance. Furthermore, as will be described later, the overall control section 30 can perform calibration processing of control timings, monitoring areas and the like of the plurality of light detection devices 5a, 5, and 5b. Moreover, the overall control section 30 can also execute control according to an external control signal supplied from the outside. In contrast, the control section 150 controls an operation of an entire ranging device 20 according to an instruction from the overall control section 30. Note that, the calibration processing will be described later in detail. Furthermore, in the present embodiment, the overall control section 30 is provided outside the ranging device 20, but the present invention is not limited thereto. For example, the overall control section 30 and the control section 150 can be formed in the same element. That is, the control section 150 can have a processing function of the overall control section 30. Moreover, each of the ranging devices 20, 20a, and 20b can have the processing function of the overall control section 30.

The clock generating section 160 generates one or more clock signals to be used in the ranging device 20 on the basis of a reference clock signal supplied from the outside. The light emission timing control section 140 generates a light emission control signal indicating a light emission timing in accordance with a light emission trigger signal supplied from the overall control section 30. The light emission control signal is supplied to the light emitting device 10 and also supplied to the ranging processing section 110. The ranging control section 120 controls an operation of the ranging processing section 110 on the basis of an instruction from the control section 150, thereby causing the ranging processing section 110 to execute generation of distance information based on the detection signal output from each pixel 1000 of the pixel array 100.

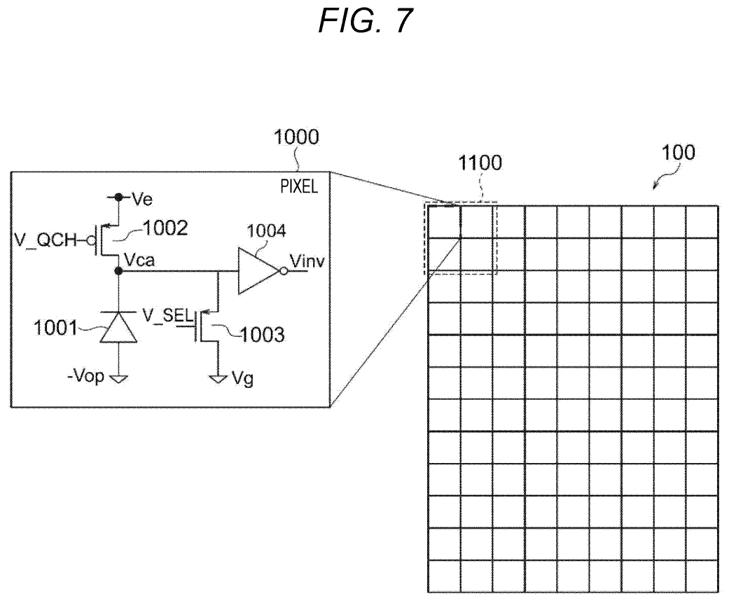

The pixel array 100 includes a plurality of pixels 1000 arranged in a matrix. The pixel 1000 is configured to generate a detection signal PLS corresponding to a light amount of detected light by detecting the light. This will be described later in detail with reference to FIG. 7.

In the present embodiment, the reflected light L1 is detected using an entire or a part of the pixel array 100. A used area in the pixel array 100 can be a rectangle elongated in a direction perpendicular to a scanning direction (up-down direction in the drawing, hereinafter also referred to as a vertical direction), the same as an image of the reflected light L1 formed on the pixel array 100 in a case where entire laser light L0 is reflected as the reflected light L1. Alternatively, in the calibration processing, this may be a rectangle elongated in a direction parallel to the scanning direction (left-right direction in the drawing, hereinafter also referred to as a horizontal direction). Note that, the present invention is not limited thereto, and various modifications such as an area larger or an area smaller than the image of the reflected light L1 formed on the pixel array 100 may be made. Note that, the pixel array 100 according to the present embodiment corresponds to a pixel array section.

The drive circuit 130 includes a shift register, an address decoder and the like, and drives each pixel 1000 of the pixel array 100 at the same time for all pixels, in units of columns and the like. Therefore, the drive circuit 130 includes at least a circuit that applies a quench voltage V QCH to be described later to each pixel 1000 in a selected column in the pixel array 100, and a circuit that applies a selection control voltage V SEL to be described later to each pixel 1000 in the selected column. Then, the drive circuit 130 applies the selection control voltage V SEL to a pixel drive line LD corresponding to a column to be read, thereby selecting the pixels 1000 to be used for detecting incidence of a photon in units of columns.

The detection signal output from the pixel array 100 is supplied to the ranging processing section 110. The ranging processing section 110 includes a TDC section 111, a histogram generating section 112, and a signal processing section 113.

The detection signal PLS read from each pixel 1000 is supplied to the TDC section 111. Here, the detection signal is read at a predetermined sampling cycle, for example, for each pixel column in the pixel array 100, and is supplied to the TDC section 111.

The TDC section 111 measures a time difference from a reference timing (for example, a timing at which the light emission control signal is input from the light emission timing control section 140) to an input of the detection signal PLS supplied from the pixel array 100, and generates digital information indicating the measured time difference. That is, on the basis of the light emission control signal and the detection signal PLS, the TDC section 111 generates time information indicating a time of flight from when light is emitted from the light source section 10 and reflected by the target 50 to be incident on each pixel 1000.

The histogram generating section 112 generates a histogram on the basis of the time information generated by the TDC section 111. Here, the histogram generating section 112 counts the time information on the basis of a unit time d set by the ranging control section 120 and generates the histogram. The unit time d may be, for example, a time width allocated to one bin in the histogram. Furthermore, the unit time d may be, for example, the same time width as the sampling cycle in which the detection signal is read from each pixel 1000 of the pixel array 100.

The signal processing section 113 performs predetermined arithmetic processing on the basis of the data of the histogram generated by the histogram generating section, and calculates, for example, distance information. For example, the signal processing section 113 creates curve approximation of the histogram on the basis of the data of the histogram. The signal processing section 113 can detect a peak of the curve approximated by the histogram and obtain a distance D to the target 50 on the basis of the detected peak. Furthermore, the signal processing section 113 can generate a two-dimensional distance image using the distance information generated on the basis of the histogram of each pixel 1000.

The distance information and the distance image output from the ranging processing section 110 are supplied to the output section 170. The output section 170 is also referred to as an interface section, and outputs the distance information and the distance image supplied from the ranging processing section to the outside as output data. As the output section 170, for example, a mobile industry processor interface (MIPI) can be applied.

The overall control section 30 is configured to control an operation of the ranging system 1 by supplying the control signal to the light emitting device 10 and the ranging device 20 and controlling an operation thereof. Note that, as described above, in a case where the overall control section 30 is formed in the control section 150, the control section 150 is configured to supply the control signal to each of the light emitting devices 10, 10a, and 10b and the ranging devices 20, 20a, and 20b and control the operation thereof, thereby controlling the operation of the ranging system 1.

### Flash-Type Optical System

FIG. 5 is a diagram illustrating an example of a flash-type optical system. As illustrated in FIG. 5, it is possible to make a so-called flash-type optical system in which the angle of view of the ranging system 1 is fixed. In this case, as illustrated in FIG. 5, a light source 11, a lens 17, a condenser lens 18, and a pixel array 100 are provided. In the light source 11, the laser light emitted from the light source 11 is converted into a light flux B10 having a necessary and sufficient divergence angle via the lens 17, and an entire ranging range AR is irradiated with the laser light. In this case, light emission control can be performed for each light emitting element 101 (refer to FIG. 4). For example, light emission control in units of one row or one column is also possible. The laser light L0 reflected by the target 50 present in the ranging range is incident on the pixel array 100 via the condenser lens 18 as the reflected light L1. In this manner, in the flash-type ranging system 1 capable of measuring the entire ranging range by one light emission, a drive section 16, a half mirror 13, and a polygon mirror 14 for scanning the ranging range are not required, therefore, there is an advantage that the optical system can be small in size as compared with a scan-type ranging system 1 to be described later.

### Scan-Type Optical System

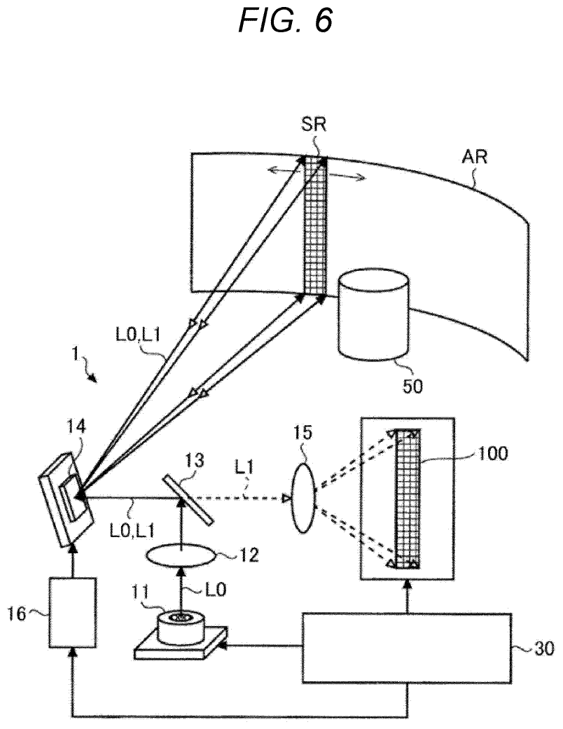

FIG. 6 is a diagram illustrating a schematic configuration of an optical system of the ranging system 1 according to the present embodiment. FIG. 6 illustrates a so-called scan-type optical system that scans the angle of view of the ranging device 20 in a horizontal direction.

As illustrated in FIG. 6, the ranging system 1 includes a light source 11, a lens 12, the half mirror 13, the polygon mirror 14, a light receiving lens 15, and the pixel array 100 as the optical system. The light source 11, the lens 12, the half mirror 13, and the polygon mirror 14 are included in the light emitting device 10 in FIG. 1, for example. Furthermore, the light receiving lens 15 is included in the light receiving section optical system 40 in FIG. 1. Note that, the half mirror 13 and the polygon mirror 14 may be shared by the light source section 10 and the light receiving section optical system 40.

In the configuration illustrated in FIG. 6, the laser light L0 emitted from the light source 11 is converted by the lens 12 into a rectangular parallel light flux B10 of which intensity spectrum of a cross section is elongated in the vertical direction, and thereafter is incident on the half mirror 13. The half mirror 13 reflects a part of the incident laser light L0. The laser light L0 reflected by the half mirror 13 is incident on the polygon mirror 14. The polygon mirror 14 vibrates in the horizontal direction with a predetermined rotation axis as a vibration center by the drive section 16 that operates on the basis of the control by the overall control section 30, for example. As a result, the laser light L0 scans horizontally in such a manner that an angle of view SR of the laser light L0 reflected by the polygon mirror 14 reciprocately scans the ranging range AR in the horizontal direction. Note that, a micro electro mechanical system (MEMS), a micromotor and the like can be used for the drive section 16.

The laser light L0 reflected by the polygon mirror 14 is reflected by the target 50 present in the ranging range AR and is incident on the polygon mirror 14 as the reflected light L1. A part of the reflected light L1 incident on the polygon mirror 14 is transmitted through the half mirror 13 and incident on the light receiving lens 15, thereby forming an image in a specific area in the pixel array 100. Note that, the specific area may be the entire pixel array 100 or a part thereof.

### Pixel Array

FIG. 7 is a diagram illustrating an example of a schematic configuration of the pixel array 100 illustrated in FIG. 3. As illustrated in FIG. 7, the pixel array 100 includes a plurality of pixels 1000 arranged in a matrix direction, and each pixel 1000 includes a photoelectric conversion section 1001, a quench resistor 1002, a selection transistor 1003, and an inverter 1004. For example, the quench resistor 1002 may include a PMOS transistor.

The photoelectric conversion section 1001 converts the incident light into an electric signal by photoelectric conversion to output. The photoelectric conversion section 1001 converts incident photon (photon) into an electric signal by photoelectric conversion and outputs a pulse according to incidence of the photon. As the photoelectric conversion section 1001, for example, a single photon avalanche diode (SPAD) is used. The SPAD has a characteristic that electrons generated in response to incidence of one photon cause avalanche multiplication so that a large current flows when a large negative voltage that generates the avalanche multiplication is applied to a cathode. When this characteristic of the SPAD is used, the incidence of one photon can be detected with high sensitivity. Here, the photoelectric conversion section 1001 corresponds to a specific example of a “photoelectric conversion section” in the present disclosure.

In FIG. 7, in the photoelectric conversion section 1001, a cathode is connected to a drain of the quench resistor 1002 and an anode is connected to a voltage source of a negative voltage (−Vop) corresponding to a voltage Vbd that is a breakdown voltage of the photoelectric conversion section 1001. A source of the quench resistor 1002 is connected to a power supply voltage Ve. A quench voltage V_QCH is input to a gate of the quench resistor 1002. The quench resistor 1002 is a current source that outputs a current corresponding to the power supply voltage Ve and the quench voltage V_OCH from the drain. With such a configuration, a reverse bias is applied to the photoelectric conversion section 1001. Furthermore, a photocurrent flows in a direction from the cathode toward the anode of the photoelectric conversion section 1001.

More specifically, in the photoelectric conversion section 1001, when the photon is incident in a state in which the power supply voltage Ve is applied to the cathode and the voltage between the cathode and the anode is a voltage Ve+Vop, the avalanche multiplication is started, a current flows from the cathode toward the anode, and accordingly, a voltage drop occurs in the photoelectric conversion section 1001. By this voltage drop, when the voltage between the cathode and the anode of the photoelectric conversion section 1001 drops to a voltage Vop, the avalanche multiplication is stopped (quenching operation). Thereafter, the photoelectric conversion section 1001 is charged with the current (recharge current) from the quench resistor 1002 as the current source, and a state of the photoelectric conversion section 1001 returns to a state before photon incidence (recharge operation).

A voltage Vca extracted from a connection point between the drain of the quench resistor 1002 and the cathode of the photoelectric conversion section 1001 is input to the inverter 1004. The inverter 1004 performs threshold determination on the input voltage Vca on the basis of a threshold voltage Vth, and inverts an output signal Vinv every time the voltage Vca exceeds the threshold voltage Vth in a positive direction or a negative direction.

More specifically, the inverter 1004 inverts the signal Vinv at a first timing when the voltage Vca exceeds the threshold voltage Vth in the voltage drop due to the avalanche multiplication corresponding to the incidence of the photon on the photoelectric conversion section 1001. Next, the photoelectric conversion section 1001 is charged by the recharge operation, and the voltage Vca rises. The inverter 1004 inverts the signal Vinv again at a second timing when this rising voltage Vca exceeds the threshold voltage Vth. A width in a time direction between the first timing and the second timing becomes an output pulse according to the incidence of the photon on the photoelectric conversion section 1001. This output pulse corresponds to the detection signal PLS described with reference to FIG. 1.

The selection transistor 1003 is, for example, an NMOS transistor, a drain of which is connected to the connection point between the drain of the quench resistor 1002 and the cathode of the photoelectric conversion section 1001, and a source of which is connected to a voltage Vg. The voltage Vg may be a GND voltage (0 V) or a negative voltage. A gate of the selection transistor 1003 is connected to the drive circuit 130, and when the selection control voltage V SEL from the drive circuit 130 is applied to the gate via the pixel drive line LD, the selection transistor 1003 changes from an off state to an on state.

An output state of the pixel 1000 operates as follows, for example. During a period in which the selection transistor 1003 is in the off state (non-connection period), the power supply voltage Ve is supplied to the cathode of the photoelectric conversion section 1001, so that when the photon is incident on the photoelectric conversion section 1001, the voltage drop occurs, and the output pulse is output from the pixel 1000 as described above. The pixel 1000 in this state is hereinafter referred to as an active pixel 1200. In contrast, during a period in which the selection transistor 1003 is turned on (connection period), the voltage Vg is applied to the cathode of the photoelectric conversion section 1001. That is, a voltage exceeding the breakdown voltage is not applied to the photoelectric conversion section 1001, and even if the photon is incident on the photoelectric conversion section 1001, no output pulse is output from the pixel 1000. The pixel 1000 in this state is hereinafter referred to as an inactive pixel.

Furthermore, as illustrated in FIG. 7, the number of pixels 1000 used to create one histogram may be plural. In this case, in the present description, a set of the plurality of pixels 1000 used to create one histogram is referred to as a macro pixel 1100 (also referred to as a pixel unit). The macro pixel 1100 includes, for example, m×n (m and n are each an integer of 2 or larger) pixels 1000. In this manner, in a case where one macro pixel 1100 corresponds to one pixel of a depth image (two-dimensional distance image), the number of pixels 1000 in which the incidence of the photon is detected among the plurality of pixels 1000 forming one macro pixel 1100 is output as the detection signal. Note that, the depth image may be image data in which a value of each pixel is distance information determined on the basis of the histogram.

### Calibration Processing

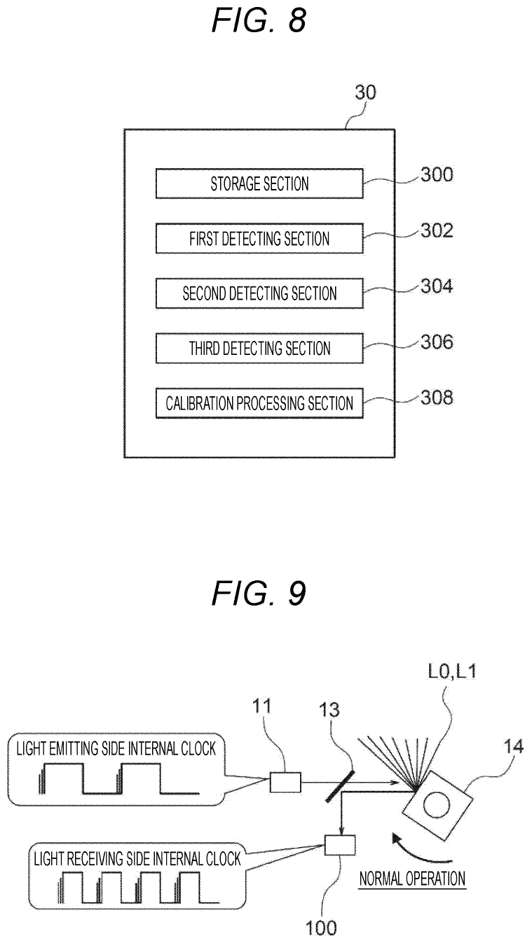

FIG. 8 is a block diagram illustrating a configuration regarding the calibration processing of the overall control section 30. The overall control section 30 includes a storage section 300, a first detecting section 302, a second detecting section 304, a third detecting section 306, and a calibration processing section 308. The calibration processing of the overall control section 30 has three inspection modes. A first mode is a mode for detecting a clock deviation between the light emitting device 10 and the ranging device 20. A second mode is a mode for detecting positional displacement between the plurality of ranging devices 20, 20a, and 20b. A third mode is a mode for detecting and setting ranging timings of the plurality of light detection devices 5, 5a, and 5b.

Furthermore, as described above, the overall control section 30 can be formed in the control section 150. Therefore, in the present embodiment, the overall control section 30 will be described as an example, but the present invention is not limited thereto. That is, each control section 150 of the ranging devices 20, 20a, and 20b may include the storage section 300, the first detecting section 302, the second detecting section 304, the third detecting section 306, and the calibration processing section 308. In this case also, the calibration processing of each control section 150 has three inspection modes. A first mode is a mode for detecting a clock deviation between the light emitting device 10 and the ranging device 20. A second mode is a mode for detecting positional displacement between the plurality of ranging devices 20, 20a, and 20b. A third mode is a mode for detecting and setting ranging timings of the plurality of light detection devices 5, 5a, and 5b.

As illustrated in FIG. 8, the storage section 300 stores a program for executing detection processing. Furthermore, data for calibration processing or correction processing detected in the first to third modes is stored.

### First Mode

First, the detection processing in the first mode will be described with reference to FIGS. 9 to 13. The first detecting section 302 executes the detection processing in the first mode.

FIG. 9 is a diagram schematically illustrating a normal operation of the scan-type optical system. In the scan-type optical system (refer to FIG. 6), in the normal operation, the target 50 is irradiated with the laser light (irradiation light) L0 from the laser light emitting element 101 (refer to FIG. 4) of the light emitting device 10, and the light pulse (reflected light pulse L1) reflected by the target 50 is incident on the pixel array 100 of the ranging device 20. In this case, the light emitting device 10 and the ranging device 20 are controlled according to independent clocks in some cases. For example, the clock on a light emitting side is 62.5 MHz, and the clock on a light receiving side is a sampling cycle at 1 GHz.

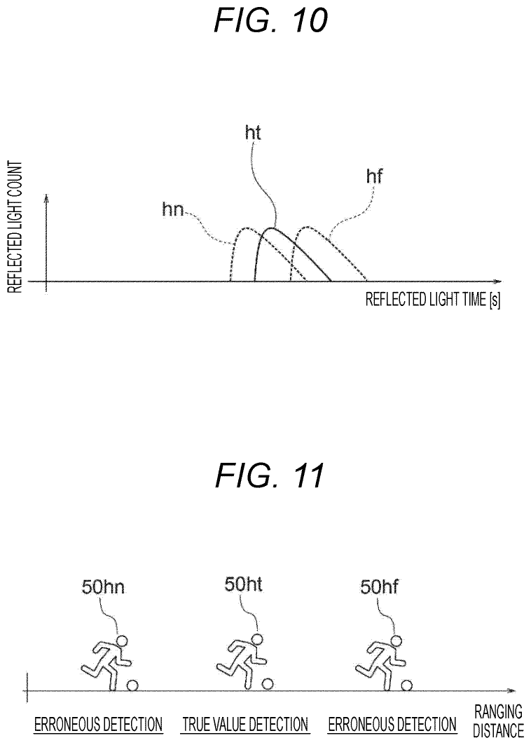

FIG. 10 is a diagram illustrating a histogram example during the normal operation of FIG. 9. An elapsed time from when the laser light emitting element 101 emits light to when the pixel array 100 receives the photon is plotted along the abscissa. The number of times by which the pixel array 100 receives the photon is plotted along the ordinate. That is, the detection signal PLS output from the pixel array 100 corresponds to the measurement time measured by the TDC section 111. As described above, the TDC section 111 measures a time difference from a reference timing (for example, a timing at which the light emission control signal is input from the light emission timing control section 140) to an input of the detection signal PLS supplied from the pixel array 100, and measures the measured time difference. The histogram can be generated by the histogram generating section 112 (refer to FIG. 3), for example, on the basis of the measured time difference.

A histogram ht is a histogram in a case where there is no deviation between an internal clock on the light emitting side and an internal clock on the light receiving side. That is, this is a case where the light emission timing of the laser light emitting element 101 (refer to FIG. 4) and a measurement start timing of the pixel array 100 coincide with each other according to the above-described reference timing. A histogram hn is an example in which the internal clock on the light receiving side is delayed from the internal clock on the light emitting side. That is, this is a case where the measurement start timing is delayed from the light emission timing. A histogram hf is an example in which the internal clock on the light receiving side is advanced from the internal clock on the light emitting side. That is, this is a case where the measurement start timing is advanced from the light emission timing.

FIG. 11 is a diagram schematically illustrating a ranging distance of the target 50. The ranging distance of the target 50 in a case where the histogram hn is used is schematically represented by 50hn. Similarly, the ranging distance of the target 50 in a case where the histogram ht is used is schematically represented by 50ht. Similarly, the ranging distance of the target 50 in a case where the histogram hf is used is schematically represented by 50hf.

As illustrated in FIGS. 10 and 11, in a case where the internal clock on the light receiving side is delayed from the internal clock on the light emitting side, the measurement start timing of the pixel array 100 is delayed from the light emission timing of the laser light emitting element 101 (refer to FIG. 4). As a result, the target 50 is ranged as the target 50hn on a shorter distance side than the target 50ht (true value).

In contrast, in a case where the internal clock on the light receiving side is advanced from the internal clock on the light emitting side, the measurement start timing of the pixel array 100 is advanced from the light emission timing of the laser light emitting element 101 (refer to FIG. 4). As a result, the target 50 is ranged as the target 50hf on a longer distance side than the target 50ht.

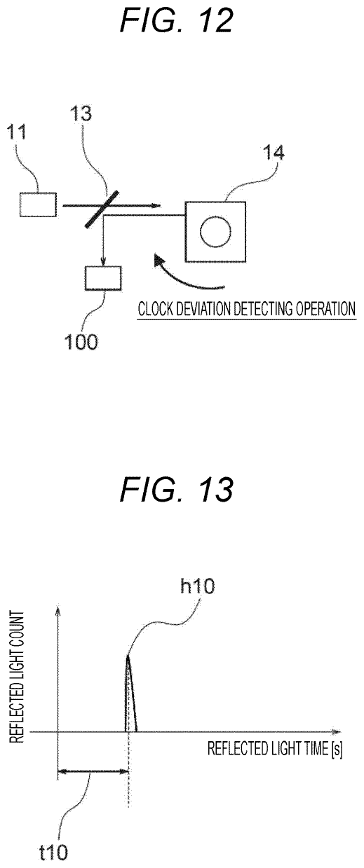

In the first mode, the first detecting section 302 detects such deviation between the light emission timing and the measurement start timing and calibrates the same. FIG. 12 is a diagram schematically illustrating an example of detecting a deviation between the light emission timing and the measurement start timing. As illustrated in FIG. 12, the first detecting section 302 controls the orientation of the polygon mirror 14 to a position at which the light pulse (reflected light pulse L1) obtained by reflecting the laser light (irradiation light) L0 by the polygon mirror 14 is directly incident on the pixel array 100 of the ranging device 20. In this manner, the first detecting section 302 controls the orientation of the polygon mirror 14 to a position at which the laser light (irradiation light) L0 is reflected in a housing. Note that, the polygon mirror 14 according to the present embodiment corresponds to a mirror.

FIG. 13 is a diagram illustrating a histogram example in the first mode. An elapsed time from when the laser light emitting element 101 emits light to when the pixel array 100 receives the photon is plotted along the abscissa. The number of times by which the pixel array 100 receives the photon is plotted along the ordinate. That is, a time difference t10 from a reference timing (for example, a timing at which the light emission control signal is input from the light emission timing control section 140) to an input of the detection signal PLS supplied from the pixel array 100 to the TDC 111 (refer to FIG. 3) is indicated. The histogram h10 can be generated by the histogram generating section 112 (refer to FIG. 3), for example, on the basis of the measured time difference.

A distance K1 from the laser light emitting element 101 to the polygon mirror 14 and a distance K2 from the polygon mirror 14 to the pixel array 100 are known by design values and the like. Therefore, a difference (t10−t10true) between a time t10true obtained by dividing a distance K1+K2 by a high speed C and the measured time difference t10 corresponds to the time of the timing deviation. That is, when t10−t10true is negative, this indicates that the measurement start timing of the pixel array 100 is delayed from the light emission timing of the laser light emitting element 101 (refer to FIG. 4). In contrast, when t10−t10true is positive, this indicates that the measurement start timing of the pixel array 100 is advanced from the light emission timing of the laser light emitting element 101 (refer to FIG. 4).

The first detecting section 302 stores the time difference (t10−t10true) in the storage section 300. The calibration processing section 308 adds, for example, the time difference t10−t10true to the measurement start timing to calibrate the measurement deviation. In this case, the calibration processing section 308 adds the time difference t10−t10true to the measurement start timing and calibrates the measurement start timing such that the time difference (t10−t10true) becomes zero. Alternatively, when the histogram generating section 112 (refer to FIG. 3) generates the histogram, the calibration processing section 308 may cause the same to correct on the basis of the time difference t10−t10true. Alternatively, the calibration processing section 308 may calibrate the light emission timing such that the time difference (t10−t10true) becomes zero.

Note that, in a case of the flash-type optical system (refer to FIG. 5), the time difference (t10−t10true) can be calculated by arranging the target 50 at a known distance at the time of the inspection in the first mode. That is, the time t10true is calculated by doubling the known distance and dividing the same by the high speed C. This is similar between the ranging devices 20a and 20b and the target 50 arranged at a known distance. In this manner, it is possible to detect the deviation between the light emission timing of the ranging devices 20, 20a, and 20b and the measurement timing and correct.

### Second Mode

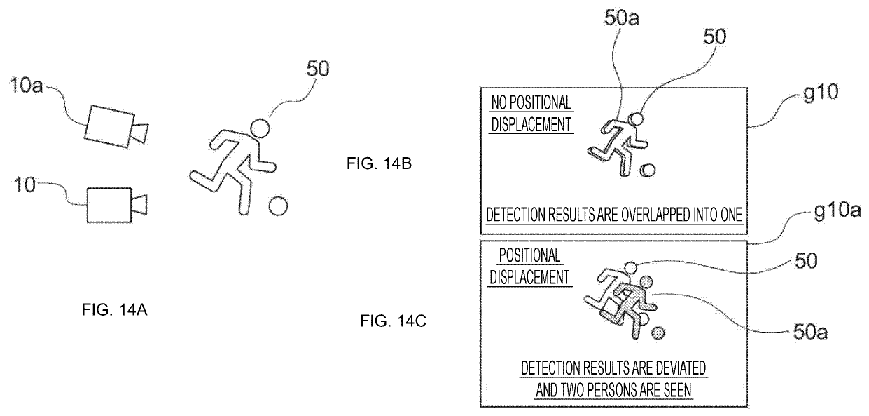

Next, the detection processing in the second mode will be described with reference to FIGS. 14 to 17. The second detecting section 304 executes the detection processing in the second mode. Note that, in the following, a case where a deviation occurs in optical axes or the like of the light emitting devices 10 and 10a will be described, but similar processing can also be performed in a case where a deviation occurs in optical axes or the like of the light emitting devices 10 and 10b.

FIG. 14 is a diagram schematically illustrating a case where the deviation occurs in the optical axes of the light emitting devices 10 and 10a. FIG. 14(a) is a diagram schematically illustrating the light emitting devices 10 and 10a and the target 50. FIG. 14(b) is a diagram schematically illustrating the overlapping area B55a (refer to FIG. 2) of the light emitting devices 10 and 10a. FIG. 14(b) illustrates a case where there is no positional displacement, and the target 50 becomes the same targets 50 and 50a in a case where the distance image is generated in the overlapping area B55a. FIG. 14(c) is a diagram schematically illustrating the overlapping area B55a (refer to FIG. 2) of the light emitting devices 10 and 10a in a case where there is the positional displacement between the light emitting devices 10 and 10a. In this case, the target 50 becomes the different targets 50 and 50a in a case where the distance image is generated in the overlapping area B55a. Such positional displacement occurs, for example, due to a change with time such as thermal expansion or vibration of the vehicle 700.

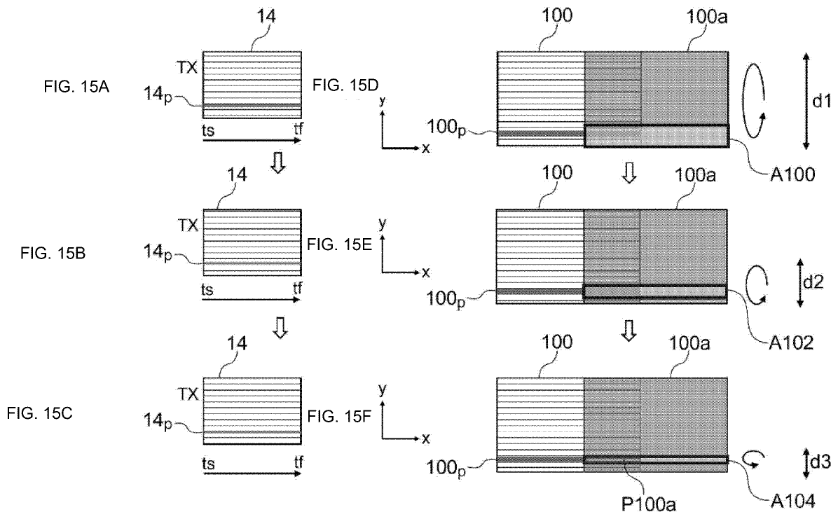

FIG. 15 is a diagram illustrating an example of detection processing in the second mode by the second detecting section 304. Here, an example of the scan-type optical system (refer to FIG. 6) will be described. FIG. 15(a) to 15(c) are diagrams illustrating a light emission pattern 14p on the polygon mirror 14. For example, this illustrates a state in which the polygon mirror rotates from a time ts to a time tf in a state in which a predetermined light emitting element 101 emits light.

FIG. 15(d) to 15(f) are diagrams schematically illustrating the pixel array 100 of the ranging device 20, a pixel array 100a of the ranging device 20a, and a light receiving state of the light emission pattern 14p. A range A10 in FIG. 15(d) indicates a drive area of the pixel array 100a. In the detection processing example in the second mode, the second detecting section 304 executes control processing of narrowing the drive area of the pixel array 100a to drive areas A102 and A104 as the inspection time elapses after capturing the position of the light emission pattern 14p.

More specifically, in FIG. 15(d), a drive range A100 of the pixel array 100 is moved from the top to the bottom or from the bottom to the top in the Y-axis direction. In this case, a first drive range d1 (an entire range in the y direction) of the pixel array 100 is driven in time series. Furthermore, a range of the area in which the histogram generating section 112 (refer to FIG. 3) generates the histogram also corresponds to the drive range A100. The second detecting section 304 acquires an addition value of the detection signals PLS for the respective pixels 1000 in the pixel array 100 from the histogram generating section 112, and detects a Y1 coordinate of the drive range A100 indicating a maximum value.

In FIG. 15(e), the drive range A100 of the pixel array 100 is narrowed to the drive range A102 and moved from the top to the bottom or from the bottom to the top. In this case, a drive range d2 in the Y-axis direction is set to a range narrower than the first drive range d1 with reference to the Y1 coordinate of the drive range A100 indicating the maximum value. That is, the second detecting section 304 moves the drive range A102 from the top to the bottom or from the bottom to the top within the second drive range d2 in the Y axis direction. Furthermore, a range of the area in which the histogram generating section 112 (refer to FIG. 3) generates the histogram also corresponds to the drive range A102. The second detecting section 304 acquires an addition value of the detection signals PLS for the respective pixels 1000 in the pixel array 100 from the histogram generating section 112, and detects a Y2 coordinate of the drive range A102 indicating a maximum value.

In FIG. 15(f), the drive range A100 of the pixel array 100 is narrowed to the drive range A104 and moved from the top to the bottom or from the bottom to the top. In this case, a drive range d3 in the Y-axis direction is set to a range narrower than the second drive range d3 with reference to the Y2 coordinate of the drive range A102 indicating the maximum value. That is, the second detecting section 304 moves the drive range A104 from the top to the bottom or from the bottom to the top within the second drive range d3 in the Y axis direction. For E example, the drive range A104 corresponds to a width of the light emission pattern 14p.

Furthermore, a range of the area in which the histogram generating section 112 (refer to FIG. 3) generates the histogram also corresponds to the drive range A102. In this case, the histogram generating section 112 generates the histogram for each pixel 1000 (refer to FIG. 7). The second detecting section 304 acquires an addition value of the detection signals PLS for the respective pixels 1000 in the pixel array 100 from the histogram generating section 112, and detects a range corresponding to the pixel 1000 exceeding a threshold as a detection area P100a. In this manner, by narrowing the detection area to A100, A102, and A104, a processing time such as a generation time of the histogram is shortened, and the detection area P100a can be detected at a higher speed. Note that, in a case of the flash-type optical system (refer to FIG. 5), similar inspection can be performed by causing the light emitting element 101 (refer to FIG. 4) in a predetermined row in the light emitting device 10 to emit light.

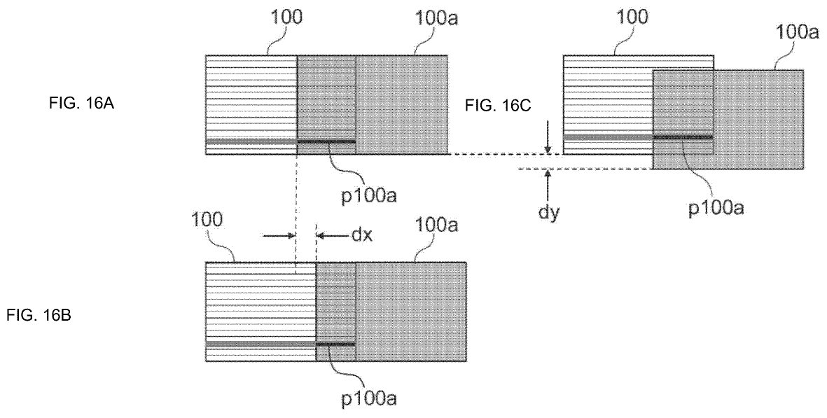

FIG. 16 is a diagram schematically illustrating coordinate correction data. FIG. 16(a) is a diagram illustrating a case where there is no coordinate deviation between the pixel array 100 of the ranging device 20 and the pixel array 100a of the ranging device 20a. FIG. 16(b) is a diagram illustrating a case where coordinate deviation occurs between the pixel array 100 of the ranging device 20 and the pixel array 100a of the ranging device 20a in an x direction. FIG. 16(c) is a diagram illustrating a case where coordinate deviation occurs between the pixel array 100 of the ranging device 20 and the pixel array 100a of the ranging device 20a in a y direction.

As illustrated in FIG. 16(b), in a case where there is the coordinate deviation in the x direction in the coordinates of the detection area P100a, a coordinate end of the detection area P100a on the pixel array 100a is different from a coordinate end of the detection area P100a illustrated in FIG. 16(a) by dx. The second detecting section 304 stores the difference dx in the storage section 300. The calibration processing section 308 causes the signal processing section 113 to generate a new coordinate based on the difference dx in the x coordinate of the pixel array 100a or the x coordinate of the pixel array 100.

For example, the calibration processing section 308 causes the signal processing section 113 to make a position obtained by adding the difference dx to the X coordinate of the pixel array 100 correspondent to the x coordinate of the pixel array 100a.

Similarly, as illustrated in FIG. 16(c), in a case where there is the coordinate deviation in the y direction in the coordinates of the detection area P100a, a coordinate end of the detection area P100a on the pixel array 100a is different from a coordinate end of the detection area P100a illustrated in FIG. 16(c) by dy. The calibration processing section 308 causes the signal processing section 113 to generate a new coordinate based on the difference dy in the y coordinate of the pixel array 100a or the y coordinate of the pixel array 100. For example, the calibration processing section 308 causes the signal processing section 113 to make a position obtained by adding the difference dy to the y coordinate of the pixel array 100 correspond to the y coordinate of the pixel array 100a.

FIG. 17 is a diagram illustrating an example in which rotational deviation such as yaw, roll, and pitch occurs in the optical system between the ranging device 20 and the ranging device 20a. In a case where processing similar to that in FIG. 15(d) to (f) is performed, the detection area P100a becomes discontinuous. In this case, the drive area is enlarged around the detection area P100a in FIG. 15(f), and a detection area P1000 is detected again. In a case where the detection area P1000 is discontinuous in the row direction of the pixel array 100a, the second detecting section 304 determines that the rotational deviation occurs.

In this case, the second detecting section 304 calculates an arithmetic value indicating a degree of rotational deviation such as yaw, roll, and pitch from a pattern of the detection area P1000, and stores the same in the storage section 300. As such pattern, a pattern generated is determined by the degree of rotational deviation such as yaw, roll, and pitch. Therefore, for example, the second detecting section 304 can correct the X and Y coordinates of the pixel array 100a according to the detected pattern.

The calibration processing section 308 causes the signal processing section 113 to perform such correction processing. That is, the coordinate of at least one of the distant images of the ranging device 20 and the ranging device 20a is corrected. As a result, as illustrated in FIG. 14(b), the positions of both the targets 50 and 50a can coincide with each other. As described above, this is similar between the ranging device 20 and the ranging device 20b. Note that, detection of the detection area P100a and the detection area P1000 on the ranging device 20 side can also be performed similarly to the ranging device 20a. Alternatively, in a case where the target 50 for inspection is installed at a predetermined position at the time of measurement in the second mode, the position of the detection area P100a on the ranging device 20 side can be calculated without measurement, and thus may be omitted.

### Third Mode

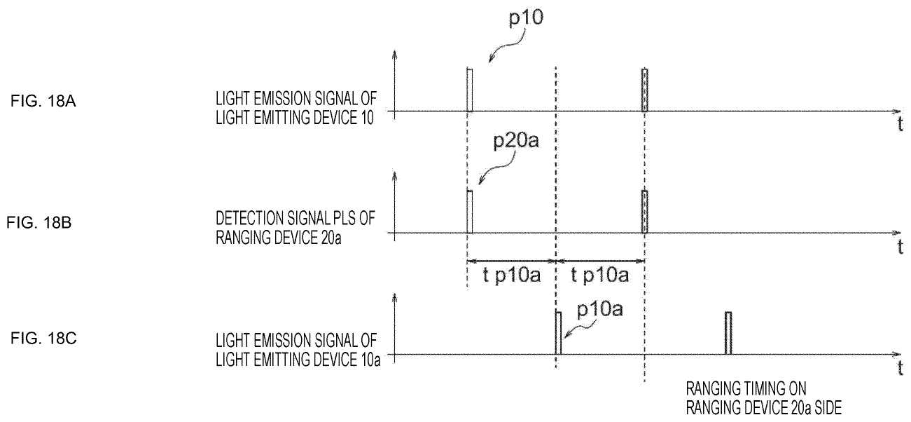

The detection processing in the third mode will be described with reference to FIG. 18. The third detecting section 306 executes the detection processing in the third mode.

FIG. 18 is a diagram schematically illustrating a detection example in the third mode. FIG. 18(a) is a diagram illustrating a light emission signal P10 of the light emitting device 10. A time is plotted along the abscissa and a high level value of the light emission signal P10 is plotted along the ordinate. That is, when the light emission signal P10 is at a high level, the light emitting device 10 sequentially emits pulsed light. For example, the light emission signal P10 has an interval of 1 us.

FIG. 18(b) is a diagram illustrating the detection signal PLS of the ranging device 20a. Here, this is an example in which all the pixels 1000 of the ranging device 20a are driven. A time is plotted along the abscissa and a high level value of the detection signal P20a is plotted along the ordinate. That is, when the detection signal P20a is at a high level, the ranging device 20a receives the reflected light.

FIG. 18(c) is a diagram illustrating the light emission signal P10a after adjustment of the light emitting device 10a in the third mode. A time is plotted along the abscissa and a high level value of a light emission signal P10a0 is plotted along the ordinate. That is, when the light emission signal P10a is at a high level, the light emitting device 10a sequentially emits pulsed light.

As illustrated in FIG. 18(a), in the detection processing in the third mode, the third detecting section 306 causes the light emitting device 10 to perform pulsed light emission according to the light emission signal P10. As illustrated in FIG. 18(b), the third detecting section 306 causes the ranging device 20a to generate a detection signal P20a for the pulsed light emission of the light emitting device 10.

As illustrated in FIG. 18(c), the third detecting section 306 sets the light emission pattern of the light emitting device 10a so that the measurement of the ranging device 20 and the measurement of the ranging device 20a do not interfere with each other. That is, the third detecting section 306 sets the light emission timing of the light emission signal p10a of the light emitting device 10a to, for example, an intermediate portion of the detection signal P20 a. In FIG. 18(b), an interval obtained by dividing the time between the detection signals P20a into two equal parts corresponds to the time tp10a. The third detecting section 306 stores the time tp10a in the storage section 300. Then, the calibration processing section 308 controls the time difference between the light emission timings of the light emitting device 10 and the light emitting device 10a as the time tp10a. Note that inspection and setting processing in the third mode between the light detection device 5 and the light detection device 5b are similarly possible.

As a result, it is possible to control so that the measurement of the ranging device 20 and that of the ranging device 20a do not interfere. Note that, in the third mode, detection processing of higher accuracy can be performed by being executed after the detection processing in the second mode and the calibration processing. Furthermore, in the detection processing in the third mode, the target 50 for inspection can be disposed at the center of the overlapping areas B55a and B55b (refer to FIG. 2) and inspected. As a result, it is possible to more efficiently suppress interference in the ranging processing with reference to the overlapping areas B55a and B55b (refer to FIG. 2).

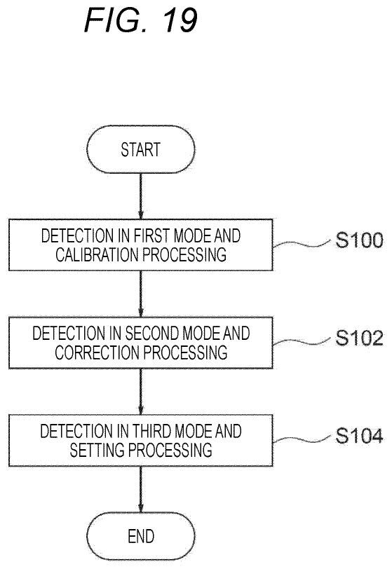

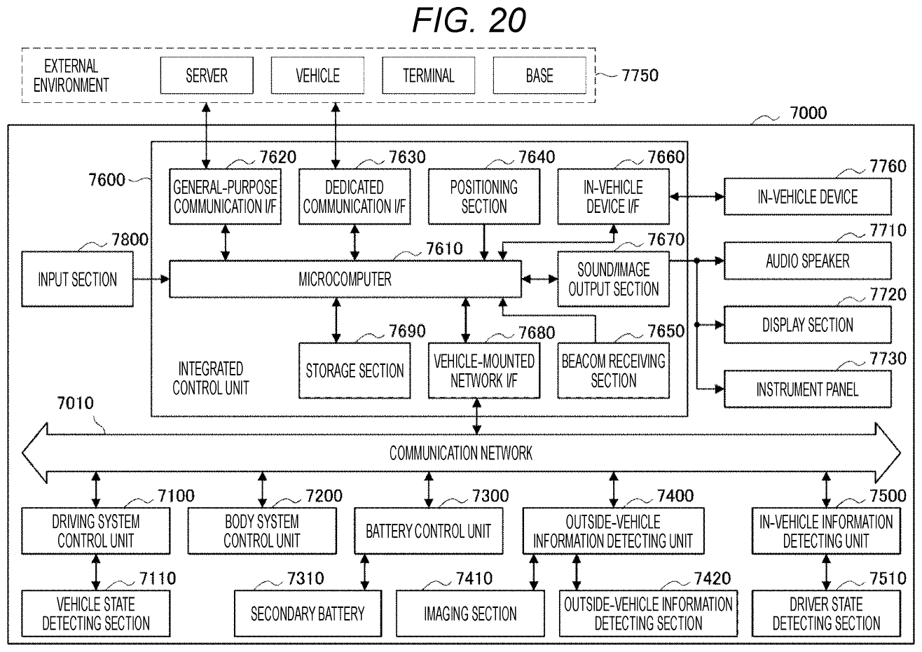

FIG. 19 is a flowchart illustrating a detection processing example according to the present embodiment. As illustrated in FIG. 20, first, the first detecting section 302 detects a deviation between the light emission timing of the laser light emitting element 101 (refer to FIG. 4) and the measurement start timing of the pixel array 100, and the calibration processing section 308 executes the calibration processing (step S100).

Next, the second detecting section 304 detects the positional displacement among the plurality of ranging devices 20, 20a, and 20b. Then, when generating the distance image, the calibration processing section 308 causes the signal processing section 113 to execute coordinate transformation based on the positional displacement (step S102).

Next, the third detecting section 306 executes an inspection for acquiring detection timings of the ranging devices 20a and 20b with respect to the light emitting device 10. Then, the calibration processing section 308 executes processing of setting light emission timings for the light emitting devices 10a and 10b. (step S104).

As described above, according to the present embodiment, the overall control section 30 has the three inspection modes, detects the clock deviation between the light emitting devices 10, 10a, and 10b and the ranging devices 20, 10a, and 20b as the first mode, detects the positional displacement between the plurality of ranging devices 20, 20a, and 20b as the second mode, and detects the light emission timing of the light emitting device 20 using the ranging devices 20a and 20b as the third mode. Then, the calibration processing section 308 calibrates the clock deviation, corrects the positional displacement, and sets the light emission timings of the light emitting devices 10, 10a, and 10b. As a result, the timing deviation or a positional displacement between the plurality of light detection devices 5, 5a, and 5b is calibrated, and a decrease in ranging accuracy is suppressed.

### Application Example

The technology according to the present disclosure can be applied to various products. For example, the technology according to the present disclosure may also be implemented as a section mounted on any type of mobile body such as an automobile, an electric automobile, a hybrid electric automobile, a motorcycle, a bicycle, a personal mobility, an airplane, a drone, a ship, a robot, a construction machine, or an agricultural machine (tractor).

FIG. 20 is a block diagram illustrating a schematic configuration example of a vehicle control system 7000 as an example of a mobile body control system to which the technology according to the present disclosure can be applied. The vehicle control system 7000 includes a plurality of electronic control units connected to each other via a communication network 7010. In the example illustrated in FIG. 20, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes a microcomputer that performs arithmetic processing according to various kinds of programs, a storage section that stores the programs executed by the microcomputer, parameters used for various kinds of calculations or the like, and a driving circuit that drives various kinds of control target sections. Each of the control units further includes a network interface (I/F) for performing communication with other control units via the communication network 7010, and a communication I/F for performing communication with a section, a sensor or the like in and outside the vehicle by wire communication or wireless communication. In FIG. 20, as a functional configuration of the integrated control unit 7600, a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690 are illustrated. The other control units similarly include a microcomputer, a communication I/F, a storage section, and the like.

The driving system control unit 7100 controls an operation of a section related to the driving system of the vehicle in accordance with various kinds of programs. For example, the driving system control unit 7100 functions as a control section for a driving force generating section for generating a driving force of the vehicle, such as an internal combustion engine or a driving motor, a driving force transmitting mechanism for transmitting the driving force to wheels, a steering mechanism for adjusting a steering angle of the vehicle, a braking section for generating a braking force of the vehicle and the like. The driving system control unit 7100 may have a function as a control section of an antilock brake system (ABS), electronic stability control (ESC) or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering section, a brake section and the like.

The body system control unit 7200 controls the operation of various kinds of sections provided to the vehicle body in accordance with various kinds of programs. For example, the body system control unit 7200 functions as a control section for a keyless entry system, a smart key system, a power window section, or various lamps such as a headlamp, a backup lamp, a brake lamp, a turn signal, and a fog lamp. In this case, radio waves transmitted from a mobile device as an alternative to a key or signals of various kinds of switches can be input to the body system control unit 7200. The body system control unit 7200 receives these input radio waves or signals, and controls a door lock section, the power window section, the lamps and the like of the vehicle.

The battery control unit 7300 controls a secondary battery 7310, which is a power supply source for the driving motor, in accordance with various kinds of programs. For example, the battery control unit 7300 is supplied with information about battery temperature, a battery output voltage, an amount of remaining capacity of the battery or the like from a battery section including the secondary battery 7310. The battery control unit 7300 performs arithmetic processing using these signals, and performs control for regulating the temperature of the secondary battery 7310 or control of a cooling section provided on the battery section or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar section, and a light detection and ranging or laser imaging detection and ranging (LIDAR) section. Each of the imaging section 7410 and the outside-vehicle information detecting section 7420 may be provided as an independent sensor or section, or may be provided as a section in which a plurality of sensors or sections is integrated.

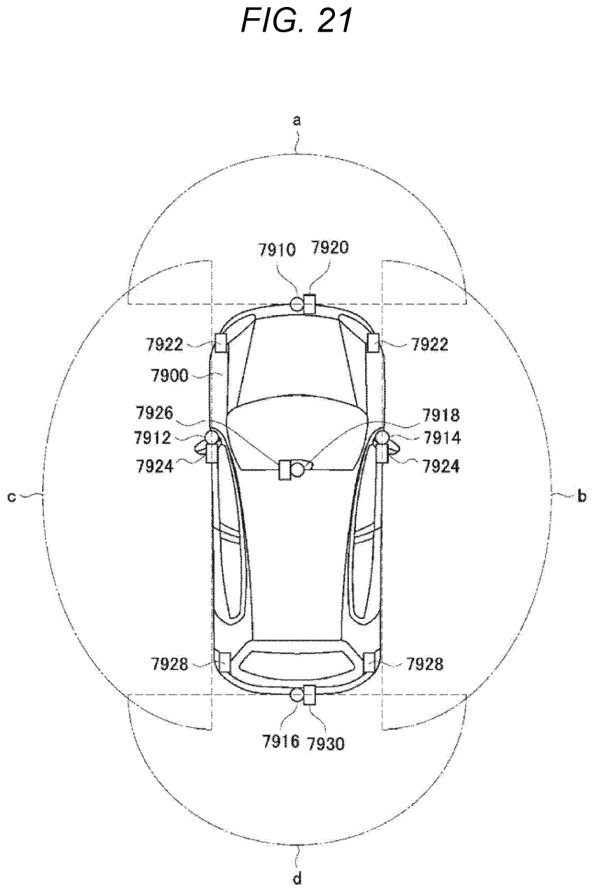

Here, FIG. 21 illustrates an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, or a back door of the vehicle 7900 or a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided on the sideview mirrors acquire mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that, FIG. 21 illustrates an example of imaging ranges of the respective imaging sections 7910, 7912, 7914, and 7916. An imaging range a indicates the imaging range of the imaging section 7910 provided to the front nose, imaging ranges b and c indicate the imaging ranges of the imaging sections 7912 and 7914 provided to the sideview mirrors, and an imaging range d indicates the imaging range of the imaging section 7916 provided to the rear bumper or the back door. A bird's-eye image of the vehicle 7900 as seen from above can be obtained by superimposing image data captured by the imaging sections 7910, 7912, 7914, and 7916, for example.

Outside-vehicle information detecting sections 7920, 7922, 7924, 7926, 7928, and 7930 provided on the front, rear, sides, and corners of the vehicle 7900 and the upper portion of the windshield within the interior of the vehicle may be, for example, an ultrasonic sensor or a radar section. The outside-vehicle information detecting sections 7920, 7926, and 7930 provided on the front nose, the rear bumper, and the back door of the vehicle 7900 and on the upper portion of the windshield within the interior of the vehicle may be, for example, a LIDAR section. These outside-vehicle information detecting sections 7920 to 7930 are used mainly to detect a preceding vehicle, a pedestrian, an obstacle, or the like.

Returning to FIG. 20, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar section, or a LIDAR section, the outside-vehicle information detecting unit 7400 transmits an ultrasonic wave, an electromagnetic wave or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a section capable of receiving an input operation by an occupant, such, for example, as a touch panel, a button, a microphone, a switch, a lever or the like. The integrated control unit 7600 may be supplied with data obtained by voice recognition of voice input through the microphone. The input section 7800 may, for example, be a remote control section using infrared rays or other radio waves, or an external connecting device such as a mobile telephone, a personal digital assistant (PDA) or the like that supports operation of the vehicle control system 7000. The input section 7800 may be, for example, a camera. In that case, an occupant can input information by gesture. Alternatively, data obtained by detecting the movement of a wearable section worn by an occupant may be input. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark) ), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 carries out V2X communication as a concept including one or more of vehicle to vehicle communication, vehicle to infrastructure communication, vehicle to home communication, and vehicle to pedestrian communication, for example.

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present in the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark) ), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. Furthermore, the in-vehicle devices 7760 may also include a navigation section that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating section, the steering mechanism, or the braking section on the basis of the obtained in-vehicle and outside-vehicle information, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. Furthermore, the microcomputer 7610 may perform cooperative control intended for automated driving, which makes the vehicle to travel automatedly without depending on the operation of the driver, and the like, by controlling the driving force generating section, the steering mechanism, the braking section or the like on the basis of the obtained information on the periphery of the vehicle.

The microcomputer 7610 may generate three-dimensional distance information between the vehicle and an object such as a surrounding structure, a person or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output section capable of visually or auditorily notifying an occupant of the vehicle or the outside of the vehicle of information. In the example in FIG. 20, an audio speaker 7710, a display section 7720, and an instrument panel 7730 are illustrated as examples of the output section. The display section 7720 may, for example, include at least one of an on-board display and a head-up display. The display section 7720 may have an augmented reality (AR) display function. The output section may be other than these sections, and may be another section such as headphones, a wearable device such as an eyeglass type display worn by an occupant or the like, a projector, a lamp or the like. In a case where the output section is a display section, the display section visually displays results obtained by various kinds of processing performed by the microcomputer 7610 or information received from another control unit in various forms such as text, an image, a table, a graph and the like. Furthermore, in a case where the output section is an audio output section, the audio output section converts an audio signal including reproduced audio data or sound data or the like into an analog signal, and auditorily outputs the analog signal.

Note that, at least two control units connected to each other via the communication network 7010 may be integrated into one control unit in the example illustrated in FIG. 20. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a section connected to any control unit may be connected to another control unit, and a plurality of control units may mutually transmit and receive detection information via the communication network 7010.

Note that, a computer program for implementing each function of the ranging system 1 according to the present embodiment described with reference to FIG. 1 can be implemented in any control unit and the like. Furthermore, a computer-readable recording medium in which such computer program is stored can be provided. The recording medium is, for example, a magnetic disk, an optical disc, a magneto-optical disk, a flash memory and the like. Furthermore, the computer program described above may be distributed via, for example, a network without using a recording medium.

In the vehicle control system 7000 described above, the ranging system 1 according to the present embodiment described with reference to FIG. 1 can be applied to the outside-vehicle information detecting unit 7400, the outside-vehicle information detecting section 7420 and the like of the application example illustrated in FIG. 20.

Note that, the present technology may have the following configurations.
(1)
A light detection device including:
a laser light source that irradiates a target with laser light on the basis of a light emission timing;
a pixel array section including a plurality of pixels each of which is capable of generating a detection signal corresponding to an amount of received light of reflected light from the target;
a signal processing section that generates a distance value to the target on the basis of information regarding a difference between the light emission timing and a generation timing of the detection signal; and
a control section capable of executing at least one of detection processing of a deviation time between the light emission timing and the generation timing of the detection signal, coordinate deviation detection processing of the plurality of pixels, and setting processing of the light emission timing.
(2)
The light detection device according to (1), in which the control section detects a deviation between the light emission timing and the generation timing of the detection signal on the basis of a measured time difference between the generation timing of the detection signal generated for reflected light of the target arranged in a predetermined position from the laser light source and the light emission timing in a case of executing the detection processing of the deviation time.
(3)
The light detection device according to (2), in which the control section detects a difference between a time obtained by dividing an added distance of a first distance from the laser light source to the position and a second distance from the position to the pixel array section by a light speed and the measured time difference as the deviation time.
(4)
The light detection device according to (3), in which the control section calibrates the light emission timing or the generation timing of the detection signal on the basis of the deviation time.
(5)
The light detection device according to (3), in which the signal processing section corrects the distance value on the basis of the deviation time.
(6)
The light detection device according to (2), further including: a mirror that changes an irradiation direction of the laser light, in which
the target is the mirror, and
the control section controls an orientation of the mirror to an orientation in which the laser light is incident on the pixel array section in a case of executing the detection processing of the deviation time.
(7)
The light detection device according to (1), in which the plurality of pixels is arranged in a matrix, and
in a case of executing the coordinate deviation detection processing,
the control section causes a second laser light source different from the laser light source to irradiate the target with laser light in a predetermined shape, and detects coordinate deviation on the basis of a first position with respect to the plurality of pixels of reflected light of the laser light in a predetermined shape.
(8)
The light detection device according to (7), in which the control section causes a second pixel array section different from the pixel array section to receive the reflected light of the laser light in a predetermined shape, and detects the coordinate deviation on the basis of a difference between a second position of the reflected light of the laser light in a predetermined shape with respect to a plurality of pixels of the second pixel array section and the first position.
(9)
The light detection device according to (8), in which the signal processing section is capable of generating a two-dimensional distance image based on detection signals of the plurality of pixels, and
the control section changes coordinates of the two-dimensional distance image on the basis of the coordinate deviation.
(10)
The light detection device according to (9), in which
the laser light in a predetermined shape is reflected as a square light pattern in a row direction of the pixel array section,
the pixel array section is capable of partially driving for each of a plurality of rectangular areas including a first side in the row direction and a second side in a column direction orthogonal to the row direction,
the control section causes the pixel array section to partially drive for each rectangular area in a case of detecting the reflected light,
selects an area in which a light receiving amount is highest among the plurality of areas and detects the first position on the basis of the area in which the light receiving amount is highest.
(11)
The light detection device according to (10), in which the control section selects the area in which the light receiving amount is highest from the plurality of areas on the basis of the detection signal, then causes the pixel array section to partially drive for each of a plurality of rectangular second areas in which the second side is made shorter, selects a second area in which the light receiving amount is highest from the plurality of second areas, and detects the first position on the basis of the second area in which the received light amount is highest.
(12)
The light detection device according to (11), in which
the control section causes the pixel array section to partially drive for each of a plurality of rectangular third areas in which the second side is made shorter in a range of the pixel array section limited on the basis of the second area in which the light receiving amount is highest, selects a third area in which the light receiving amount is highest from the plurality of third areas, and detects the first position on the basis of the third area in which the received light amount is highest.
(13)
The light detection device according to (10), in which in a case where pixels that generate the detection signal of a predetermined value or more in the area are discontinuous in the row direction, the control section detects that a rotational deviation occurs between an irradiation optical system of the second laser light source and a light receiving optical system of the pixel array section.
(14)
The light detection device according to (1), in which,
in a case of executing the setting processing of the light emission timing, the control section
causes a second laser light source different from the laser light source to irradiate the target with laser light at predetermined intervals, and
sets the light emission timing of the laser light source on the basis of the generation timing of the detection signal.
(15)
The light detection device according to (14), in which the control section sets the light emission timing of the laser light source on the basis of an intermediate point of time of generation timings of the detection signals continuous in time series.
(16)
A ranging system including: a plurality of light detection devices, irradiation ranges of laser light of which overlap with each other, in which
each of the plurality of light detection devices includes:
a laser light source that irradiates a target with laser light on the basis of a light emission timing;
a pixel array section including a plurality of pixels each of which is capable of generating a detection signal corresponding to an amount of received light of reflected light from the target; and
a signal processing section that generates a distance value to the target on the basis of information regarding a difference between the light emission timing and a generation timing of the detection signal,
and at least one light detection device of the plurality of light detection devices further includes
a control section capable of executing at least one of detection processing of a deviation time between the light emission timing and the generation timing of the detection signal, coordinate deviation detection processing of the plurality of pixels, and setting processing of the light emission timing.
(17)
A ranging system including:
a plurality of light detection devices, irradiation ranges of laser light of which overlap with each other; and
an overall control section capable of controlling each of the plurality of light detection devices, in which
each of the plurality of light detection devices includes:
a laser light source that irradiates a target with laser light on the basis of a light emission timing;
a pixel array section including a plurality of pixels each of which is capable of generating a detection signal corresponding to an amount of received light of reflected light from the target; and
a signal processing section that generates a distance value to the target on the basis of information regarding a difference between the light emission timing and a generation timing of the detection signal,
and the overall control section
is capable of executing at least one of detection processing of a deviation time between the light emission timing and the generation timing of the detection signal, coordinate deviation detection processing of the plurality of pixels, and Setting processing of the light emission timing.

Modes of the present disclosure are not limited to the individual embodiments described above, but include various modifications that may be conceived by those skilled in the art, and the effects of the present disclosure are not limited to the contents described above. In other words, various additions, modifications, and partial deletions may be made without departing from the conceptual idea and spirit of the present disclosure derived from the matters defined in claims and equivalents thereof.

### REFERENCE SIGNS LIST

1 Ranging system
5, 5a, 5b Light detection device
10 Light emitting device
14 Polygon mirror
40 Light receiving section optical system
50 Target
100 Pixel array
113 Signal processing section
150 Control section
300 Overall control section
1000 Pixel L0 Laser light L1 Reflected light

1. A light detection device comprising:
a laser light source that irradiates a target with laser light on a basis of a light emission timing;
a pixel array section including a plurality of pixels each of which is capable of generating a detection signal corresponding to an amount of received light of reflected light from the target;
a signal processing section that generates a distance value to the target on a basis of information regarding a difference between the light emission timing and a generation timing of the detection signal; and
a control section capable of executing at least one of detection processing of a deviation time between the light emission timing and the generation timing of the detection signal, coordinate deviation detection processing of the plurality of pixels, and setting processing of the light emission timing.

2. The light detection device according to claim 1, wherein the control section detects a deviation between the light emission timing and the generation timing of the detection signal on a basis of a measured time difference between the generation timing of the detection signal generated for reflected light of the target arranged in a predetermined position from the laser light source and the light emission timing in a case of executing the detection processing of the deviation time.

3. The light detection device according to claim 2, wherein the control section detects a difference between a time obtained by dividing an added distance of a first distance from the laser light source to the position and a second distance from the position to the pixel array section by a light speed and the measured time difference as the deviation time.

4. The light detection device according to claim 3, wherein the control section calibrates the light emission timing or the generation timing of the detection signal on a basis of the deviation time.

5. The light detection device according to claim 3, wherein the signal processing section corrects the distance value on a basis of the deviation time.

6. The light detection device according to claim 2, further comprising: a mirror that changes an irradiation direction of the laser light, wherein
the target is the mirror, and
the control section controls an orientation of the mirror to an orientation in which the laser light is incident on the pixel array section in a case of executing the detection processing of the deviation time.

7. The light detection device according to claim 1, wherein the plurality of pixels is arranged in a matrix, and
in a case of executing the coordinate deviation detection processing,
the control section causes a second laser light source different from the laser light source to irradiate the target with laser light in a predetermined shape, and detects coordinate deviation on a basis of a first position with respect to the plurality of pixels of reflected light of the laser light in a predetermined shape.

8. The light detection device according to claim 7, wherein the control section causes a second pixel array section different from the pixel array section to receive the reflected light of the laser light in a predetermined shape, and detects the coordinate deviation on a basis of a difference between a second position of the reflected light of the laser light in a predetermined shape with respect to a plurality of pixels of the second pixel array section and the first position.

9. The light detection device according to claim 8, wherein the signal processing section is capable of generating a two-dimensional distance image based on detection signals of the plurality of pixels, and
the control section changes coordinates of the two-dimensional distance image on a basis of the coordinate deviation.

10. The light detection device according to claim 9, wherein the laser light in a predetermined shape is reflected as a square light pattern in a row direction of the pixel array section,
the pixel array section is capable of partially driving for each of a plurality of rectangular areas including a first side in the row direction and a second side in a column direction orthogonal to the row direction,
the control section causes the pixel array section to partially drive for each rectangular area in a case of detecting the reflected light, selects an area in which a light receiving amount is highest among the plurality of areas and detects the first position on a basis of the area in which the light receiving amount is highest.

11. The light detection device according to claim 10, wherein
the control section selects the area in which the light receiving amount is highest from the plurality of areas on a basis of the detection signal, then causes the pixel array section to partially drive for each of a plurality of rectangular second areas in which the second side is made shorter, selects a second area in which the light receiving amount is highest from the plurality of second areas, and detects the first position on a basis of the second area in which the received light amount is highest.

12. The light detection device according to claim 11, wherein
the control section causes the pixel array section to partially drive for each of a plurality of rectangular third areas in which the second side is made shorter in a range of the pixel array section limited on a basis of the second area in which the light receiving amount is highest, selects a third area in which the light receiving amount is highest from the plurality of third areas, and detects the first position on a basis of the third area in which the received light amount is highest.

13. The light detection device according to claim 10, wherein
in a case where pixels that generate the detection signal of a predetermined value or more in the area are discontinuous in the row direction, the control section detects that a rotational deviation occurs between an irradiation optical system of the second laser light source and a light receiving optical system of the pixel array section.

14. The light detection device according to claim 1, wherein, in a case of executing the setting processing of the light emission timing, the control section
causes a second laser light source different from the laser light source to irradiate the target with laser light at predetermined intervals, and
sets the light emission timing of the laser light source on a basis of the generation timing of the detection signal.

15. The light detection device according to claim 14, wherein the control section sets the light emission timing of the laser light source on a basis of an intermediate point of time of generation timings of the detection signals continuous in time series.

16. A ranging system comprising: a plurality of light detection devices, irradiation ranges of laser light of which overlap with each other, wherein
each of the plurality of light detection devices includes:
a laser light source that irradiates a target with laser light on a basis of a light emission timing;
a pixel array section including a plurality of pixels each of which is capable of generating a detection signal corresponding to an amount of received light of reflected light from the target; and
a signal processing section that generates a distance value to the target on a basis of information regarding a difference between the light emission timing and a generation timing of the detection signal,
and at least one light detection device of the plurality of light detection devices further includes a control section capable of executing at least one of detection processing of a deviation time between the light emission timing and the generation timing of the detection signal, coordinate deviation detection processing of the plurality of pixels, and setting processing of the light emission timing.

17. A ranging system comprising: a plurality of light detection devices, irradiation ranges of laser light of which overlap with each other; and
an overall control section capable of controlling each of the plurality of light detection devices, wherein
each of the plurality of light detection devices includes:
a laser light source that irradiates a target with laser light on a basis of a light emission timing;
a pixel array section including a plurality of pixels each of which is capable of generating a detection signal corresponding to an amount of received light of reflected light from the target; and
a signal processing section that generates a distance value to the target on a basis of information regarding a difference between the light emission timing and a generation timing of the detection signal,
and the overall control section is capable of executing at least one of detection processing of a deviation time between the light emission timing and the generation timing of the detection signal, coordinate deviation detection processing of the plurality of pixels, and setting processing of the light emission timing.
